(19) United States
(12) Patent Application Publication
(10) Pub. No.: US 2010/0082362 A1
(43) Pub. Date: Apr. 1, 2010

(54) Method and Apparatus for Assessing Salient Characteristics of a Community

(76) Inventors: Baker Salsbury, Tolland, CT (US); Elaine O'Keefe, Easton, CT (US); Jennifer Kertanis, Granby, CT (US); David Carroll, Torrington, CT (US)

Correspondence Address: ALIX YALE & RISTAS LLP, 750 MAIN STREET, SUITE 1400, HARTFORD, CT, 06103, US

(21) Appl. No.: 12/584,933

(22) Filed: Sep. 15, 2009

Related U.S. Application Data
(60) Provisional application No. 61/192,485, filed on Sep. 17, 2008.

(51) Int. Cl. G06Q 99/00; G06F 17/30; G06F 3/048

(52) U.S. Cl. 705/1.1; 707/749; 707/741; 715/771; 707/E17.002

(57) ABSTRACT

A computer system and method comprising census data on neighborhood level communities, each data point representing a quantitative value indicative of one of a plurality of components of community health. Executable instructions combine with weighted importance, the quantitative indicator values into a plurality of components of community health. Each component represents a quantitative value associated with one of a plurality of determinants of community health. Executable instructions combine with weighted importance, the quantitative component values into a determinant of community health. Each of the determinants represents a quantitative contribution to an overall health index of the community. The index is computed from the determinants and can be compared with similarly computed indices for other communities. The indices, determinants, components, and indicators for a given community can be compared across communities and correlated with data on specific health outcomes across communities to identify health outcome disparities.

### RELATED APPLICATION

Priority is claimed under 35 U.S.C. 119(e) from Provisional App. No. 61/192,485 filed Sep. 17, 2008 for “Method and Apparatus for Assessing Salient Characteristics of a Community”.

### BACKGROUND

The present invention relates to systems and methods for collecting, analyzing and evaluating community data, especially data by which the health of a community can be related to the environmental, social, and political conditions of a community.

Public health officials are increasingly looking to share information and coordinate actions to improve the health of the public they serve. Recently, such officials as well as legislatures and public interest foundations, have become concerned with disparities in the directly observable conditions of health within large population groups such as towns, cities, counties and states. There is a growing realization that government, charities, and similar institutions should take steps to reduce inequities in the health conditions within such populations.

### SUMMARY OF THE INVENTION

The present invention has roots in a policy statement issued by the Center for Disease Control and Prevention, entitled Healthy People 2010, commonly know as “HP 2010”, which recognizes the need to take a multi-disciplinary approach to achieving health equity.

The inventors believe that not only health inequities, but factors that contribute to health inequities, can be measured at the community level and thus they can be changed at the community level. The nation's 3000 public health departments are an appropriate vehicle for such change, if they can be provided with an effective tool for portraying and analyzing the health of their respective communities.

The present invention provides a system and methodology to determine an Index as a way to conceptualize and measure community contextual influences on population health and health disparities. It uses traditional and nontraditional domains of the social environment; both quantitative and qualitative data sources; and both statistical analysis and local community knowledge. It aims to trigger policy and regulatory improvements to reduce inequity. Such index produces
Science-based Social Epidemiology
Strong Platform for Community Engagement
Cover for Political Leaders
Credible Framework for Regulatory Change (e.g., a Health Impact Assessment Model)

Such index can be transformative. Health Departments become agents for change. Data collection provides a basis for social epidemiology. The focus can shift from individual behaviors to the examination of root causes of unhealthy communities. Health outcomes can be correlated to community conditions. At a systems level, government and foundations can focus on legislation, policies and programs that are measurably effective for primary prevention.

Indicators are the measurements used to describe the condition of a population group based on a specific characteristic or event. Indicators by themselves cannot measure or explain complex phenomena such as the social determinants of health. Researchers typically use indices and indicator systems to produce greater information about phenomena and conditions. Both are intended to be more than just a collection of indicator statistics. Both tools measure distinct components of a system. Most importantly both provide information that can illustrate how the individual components work together to produce an overall effect.

However, within this area of commonality there are distinct differences in how the tools are constructed and function. An index can be defined as a measurement tool that represents the comparison of numerous variables against reference points. In that context, it is a composite number that signifies the averaging and combining of a large group of measurements in a standardized way. Indices are useful tools for establishing benchmarks and measuring and tracking changes in social conditions or the performance of sectors such as markets and goods/services.

As composite measures, indices have inherent limitations that can mitigate their effectiveness if not properly interpreted. The primary one is reducing a multi-dimensional condition such as health equity into a single composite score. Other limitations include the arbitrary nature of selecting the units of measurement, weighting and scoring.

An indicator system is generally composed of a set of individual indicators that may or may not be classified by category. Within the existing framework, indicators can be combined in innovative ways to provide useful descriptive information about a condition. Sometimes, scoring and ranking are used, but not always. Unlike indices, indicator systems do not transform different units of measurement into common metrics that can be combined into an overall or composite score.

The Index obtainable with the present invention was developed to identify specific indicators correlated with socio-demographic data and health outcomes at the smallest local geographical unit possible to obtain accurate standardized scores. The Index database can be queried to explore and generate visual representations of the analyses through GIS mapping, tables, charts, graphs, and diagrams.

An index, despite its shortcomings, was deemed the most appropriate instrument for measuring the relationship between social determinants, population demographics, health outcomes and health equity. The use of the standardized scoring and ranking incorporated in an index was considered important for portraying and understanding the differences between very small communities, such as neighborhoods. Furthermore the composite score generated by an index is a useful summative measure for describing the impact of the social determinants. The index score also lends itself more to statistical analysis against health outcomes and demographic variables.

The inventive index framework as developed for investigation of disparities in public health at the community level has been named the Health Equity Index™ (also HEI™), and includes the following building blocks:
A set of Social Determinants
Indicators
Indicator selection criteria, indicator definitions and a rationale for their usage
Data sources
Reference points and measurement scales
Method of calculating and scoring the HEI
Method of ranking communities and/or neighborhoods
Method of analyzing the HEI index scores with health outcomes and demographics at the neighborhood level
Correlations displaying the strength of relationships between indicators and multiple health outcomes

Developing each of these building blocks required that a range of issues, both practical and political, be considered. Among them were:
Identification of social determinants that represent the context of neighborhood life, can be plausibly related to health status, and lend themselves to life span processes
Selection of indicators that adequately represent contextual characteristics of a neighborhood
Delineation of a weighting strategy to be used in calculating the overall index (factor analysis)
Availability, accessibility and affordability of data sources that support neighborhood-level indicators
Selection of health outcomes that best represent overall health status
Inclusion of measures that represent race/ethnicity in health outcomes
Selection of indicators that facilitate the analysis of the impact of laws, policies and institutional practices on the social determinants of health

The preferred form of the index was developed by
Researching existing Index Models and Indicator Projects (US and international)
Identifying Determinants of Health Equity
Identifying Indicators (the Measures)
Selecting Data Sources that can Support Indicators

The Indicator selection was based on criteria of
Availability—is available, accessible and affordable
Reliability—is based on consistently collected, compiled and calculated data
Validity—measures what it purports to measure
Measurability—is easily quantifiable and lends itself to numeric scaling
Capacity to be Disaggregated—can be disaggregated into target groups of interest based on race/ethnicity, gender, age and place of residence
Sensitivity—is able to monitor changes over time
Compelling and Interesting—lends itself to understanding and has the capability to resonate with the public, media and decision-makers.
Statistically Sound—Indicator construct (measurement and scaling) is methodologically sound and is appropriate for the purpose it is being applied. The indicator has been used in other indices or indicator systems.
Relevance/action-oriented—measures a factor or condition concerning a social determinant of health over which community stakeholders can achieve positive change through public decision-making and social/political action.

The overall or core health index and its application can thus be considered as a systematic identification, quantification and measurement of social determinants that give rise to health disparities, comprised of:
Social Determinants
Components of social determinants
Indicators of the components
Correlations between determinants, components, and indicators in association with socio-demographic data and health outcomes

The Index is useful per se as a measurement tool, and is also useful for correlation analysis against components and indicators, as well as health outcomes. Furthermore, the indicators and components can be correlated with demographic or health outcome data, apart from the core index.

The usefulness of the index is based on its capacity to quantify the size and magnitude of inequities. This capability was largely dependent on the quality of indicators used. Numerous considerations came into play that had major implications for which measures could and could not be used. Decisions therefore had to be made at the outset regarding the selection of indicators. These included:
Qualities that indicators should possess including reliability, validity, sensitivity
Integration of qualitative measures into a quantitative framework
Level of disaggregation possible—such as geographic, demographic, social group
Use of proxy indicators and
Availability of adequate data sources.

Within a multi-level analytical framework, the index should function as a bridge between social-institutional forces and social determinants on one end of the spectrum, and community action and structural change at the other end.

Desirable indicators could help analyze the role that historical context and power arrangements—as signified by laws, policies and institutional practices—play in shaping the social determinants of health. However, for embodiments of the invention whereby measures could be uniformly and consistently applied to all neighborhoods in a state, the technique for determining the core index largely uses indicators supported by administrative and census data sets.

The need for more flexible and innovative measures led to the development of Complementary Indicators. These are indicators that utilize a wider array of data sources and data collection methods. Consequently, the Complementary Indicators provide a means for deeper analysis of the root causes of inequities.

Although the system and methodology were developed for analyzing and evaluating health disparities on a community level, the system and methodology are adaptable for analyzing and evaluating other aspects of sociological conditions such as economics or housing.

A representative system and associated methodology are embodied in a computer system having a memory, an operating system for placing and retrieving data into and from the memory, an application program compatible with the operating system, and a user interface for the operating system and application program. A database is structured to receive and store in the memory, (1) census and additional data on a specified geographic community, each datum of the database representing a quantitative value indicative of one of a plurality of components of community condition; (2) executable instructions for combining with weighted importance, the quantitative indicator values into a plurality of the components of community condition, each of the components representing a quantitative value associated with one of a plurality of determinants of community condition; (3) executable instructions for combining with weighted importance, the quantitative component values into a determinant of community condition, each of the determinants representing a quantitative contribution to an index commensurate with the overall condition of the community; and (4) executable instructions for computing the index from the determinants and displaying the index on the user interface.

With the exemplary system containing data pertaining to public health, the data base preferably includes executable instructions for correlating the index with demographic data and health outcome data, and for generating a display of the correlations. The system and method can also include executable instructions for correlating at least one of the quantitative values indicative of a component of the social determinants of health with a demographic data and/or a health outcome data and correlating demographic data with health outcome data.

Apart from the operational system, an aspect of the invention is directed to computer readable media containing database data comprising a multiplicity of indicator data points and a multiplicity of health outcome data points, wherein each of the indicator data points includes a quantitative value of a social condition that influences public health and includes the data attributes of type of condition, measured value, scaled score value, geographic unit, and source of the measured value. Each of the health outcome data points includes a quantitative value of a deficiency in human health and includes the data attributes of type of deficiency, quantitative value of deficiency, scaled score value of deficiency, geographic unit, and source of the quantitative value. For each type of condition indicator at least two data values are present for at least two different geographic unit attributes from among census tract, postal zip code, voting district, telephone area code, and for each type of outcome deficiency at least two data values are present for the same at least two geographic units attributed to the two health outcome data points.

In the preferred embodiment a Core Index is obtained by combining Core Determinants that are composed of at least one Core Component, each having at least one Core Indicator. In a more streamlined embodiment, no Core Index, Core Determinants or Core Components need be developed, but indicators having the same qualities as Core Indicators are obtained and used for correlations with Demographic data and/or Health outcome data.

The important quality of an indicator as used in the present invention, is that it is indicative of a condition that is likely to affect the health of a population, measurable and scalable at a reference level (such as a state, county or city) and at a community subset level (such as a city, census tract, zip code, municipal voting district or attendance district by school).

In the preferred embodiment, the Core Determinants are broad categories of the social environment (community contextual influences) representing causes and risk factors which, based on scientific evidence or theory, are believed to directly influence the level of a specific health problem (health outcome). The Core Determinants can thus be considered as Social Determinants of Health, which are those life-enhancing resources, such as food supply, housing, economic and social relationships, transportation, education, and health care, whose distribution across populations effectively determines length and quality of life. In the preferred embodiment, the Core Indicators are the quantitative elements or building blocks derived from secondary data sources, which collectively constitute the Social Determinants of Health.

In a larger sense, the invention is designed to provide a system and method for analyzing health related “cause and effect” relationships as influenced by societal inequities, whereby each of the Index, Determinants, Components, and Core indicators, can be viewed as a potential “causation factor” in future analyses and each of the Health Outcomes can be viewed as a measurable effect in the form of disease, admissions to treatment facilities, etc. The Index provides reasonably reliable correlations and relationships that are amenable to statistical analysis, sufficient to justify the direction of public policy and the allocation of public resources.

In the representative embodiment to be described herein, only two categories of data are scaled—the core indicators and the health outcome effects. The scales are based only on the reference population in the reference political or geographic unit, in this case statewide data—using the state median as a reference point for each of them. Each indicator for a specific community has a value and, based on that value—a score in the corresponding scale. Thus comparing the scores for different communities in the same reference unit, e.g., state, becomes meaningful.

The system can reveal the direction and strength of the correlations between social determinants (at various levels, especially indicators) and health outcomes at the community level, and present the correlations in a synergistic way, such as mapping the correlations using GIS methodology to investigate disparities.

### BRIEF DESCRIPTION OF THE DRAWING

The invention is described in greater detail below with reference to the accompanying drawing, in which:

FIG. 1 is a schematic of a computer system for implementing an embodiment of the present invention;

FIG. 2 is a schematic representation of the relationship of the data elements and organization for the economic security and financial resources determinant of community health;

FIG. 3 is a schematic representation of the relationship of the data elements and organization for the livelihood security and employment opportunity determinant of community health;

FIG. 4 is a schematic representation of the relationship of the data elements and organization for the school readiness and educational attainment determinant of community health;

FIG. 5 is a schematic representation of the relationship of the data elements and organization for the environmental quality determinant of community health;

FIG. 6 is a schematic representation of the relationship of the data elements and organization for the civic involvement and political access determinant of community health;

FIG. 7 is a schematic representation of the relationship of the data elements and organization for the availability and utilization of quality health care services determinant of community health;

FIG. 8 is a schematic representation of the relationship of the data elements and organization for the affordable and safe housing determinant of community health;

FIG. 9 is a schematic representation of the relationship of the data elements and organization for the community safety and security determinant of community health;

FIG. 10 is a schematic representation of the relationship of the data elements and organization for the transportation determinant of community health;

FIG. 11 is a table that summarizes some of the kinds of data that can be correlated;

FIG. 12 is a table that shows correlations between certain types of indicators and health outcomes vs. three categories of race, for a test population.

FIG. 13 is a table that shows correlations between determinants and types of health outcomes, over a test group of 20 neighborhood communities;

FIG. 14 is a table that shows correlations between certain types of indicators and types of health outcomes, over a test group of 20 neighborhood communities;

FIG. 15 is a table showing a suitable correspondence between ranges of correlation coefficients and inferences of strength of a relationship between the variable that have been correlated;

FIG. 16 is a graphic representation of one form of output of the system, in which the geographic relationships of the communities, the health index for each community, and the asthma visits for each community can be graphically or symbolically displayed; and

FIG. 17 is a representation of the preferred database scheme as stored in the computer of FIG. 1.

### DETAILED DESCRIPTION OF REPRESENTATIVE EMBODIMENT

A more detailed description of one embodiment appears below with reference to the accompanying Figures and Appendix.

In the preferred embodiment for a health equity index, nine social determinants have been identified, with each determinant defined by one or more components. The nine social determinants are combined to arrive at the Core Index. In the present example, each determinant is given equal weight, but as an alternative the determinants could be weighted differently.

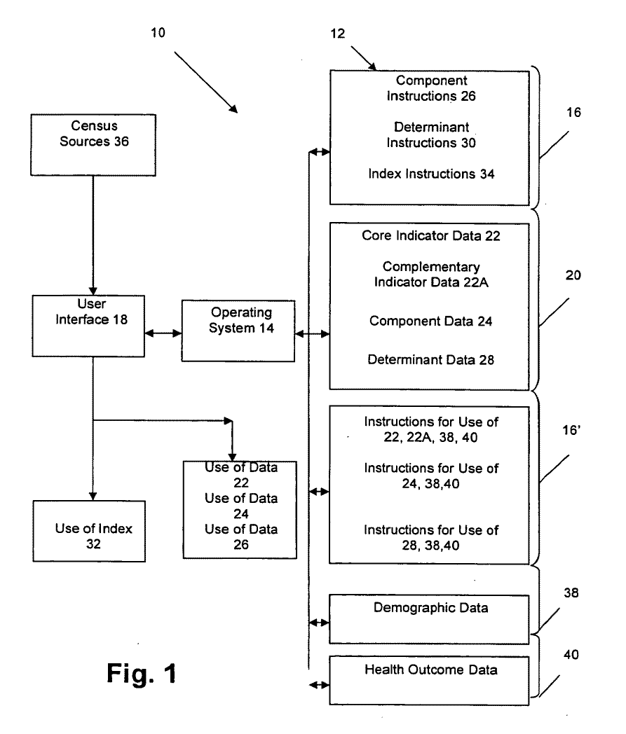

FIG. 1 is a schematic representation of a system implementation according to one embodiment of the invention. The system 10 has a memory 12, an operating system 14 for placing and retrieving data into and from the memory, an application program 16 compatible with the operating system, and a user interface 18 for the operating system and application program. As is well known, the application program can be delivered to the system on media or downloaded electronically, then opened to provide the logic and instructions by which the computer processes data. The application program configures and/or interacts with database 20 structured to receive and store in the memory, census and additional data on a specified geographic community, wherein each datum 22 represents a quantitative value indicative of one of a plurality of components 24 of community condition. The memory also includes executable instructions 26 for combining with weighted importance, the quantitative indicator values into a plurality of components of community condition, each of the components representing a quantitative value associated with one of a plurality of determinants 28 of community condition. Also, the memory includes executable instructions 30 for combining with weighted importance, the quantitative component values into a determinant 28 of community conditions. Each of the determinants represents a quantitative contribution to a core index 32 commensurate with the overall condition of the community. Executable instructions 34 are also provided for computing the index from the determinants and displaying the index on the user interface.

It should be appreciated that that the application program containing the coded instructions which define the logic and mathematical operations can be stored in the same computer readable media where the database is stored, or in a separate component of the system. Analogously, the indicator data values, the demographic data values, and health outcome data values can be stored in separate tables of the database or in one table, and the other attributes associated with each data value can be stored in the same table as the value or in another table with suitable pointers.

The overall Core Index represents the composite of nine determinants and associated indicators.
Economic Security & Financial Resources
Livelihood Security & Employment Opportunity
School Readiness & Educational Attainment
Environmental Quality
Civic Involvement & Political Access
Availability & Utilization of Quality Health Care
Adequate, Affordable & Safe Housing
Community Safety & Security
Transportation

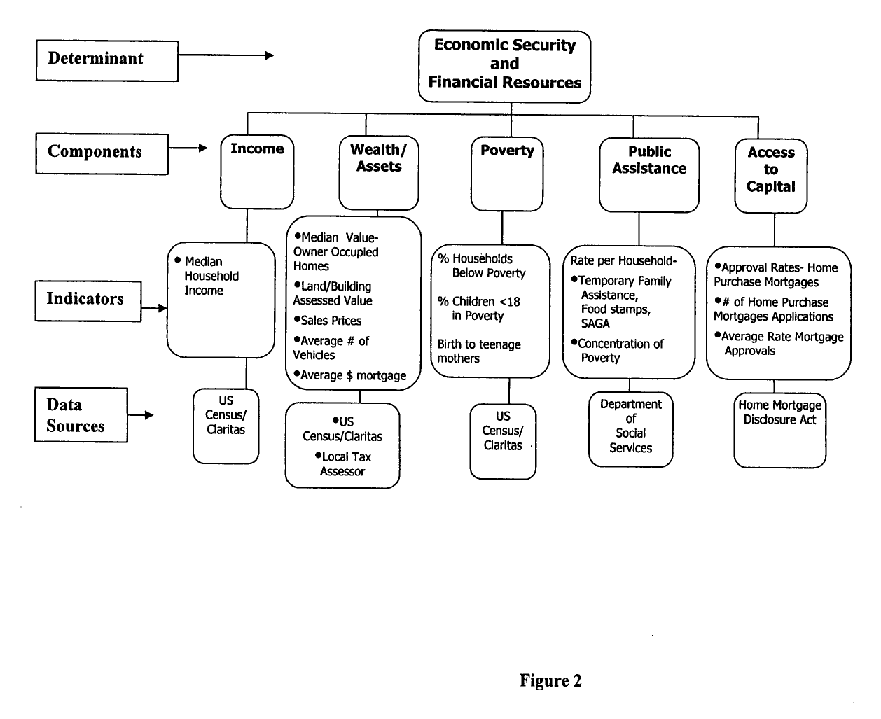

A representative relationship of the data sources, indicators, and components for the determinant of economic security/financial resources, is shown in FIG. 2. Each indicator datum 22 of the database represents a quantitative value indicative of one of a plurality of components 24 of a community condition, such as community health. The data for the indicator is derived from a “census” data source 36 from which a reference point or value for a reference community is derived, and for the same indicator, the local value for the selected community is derived.

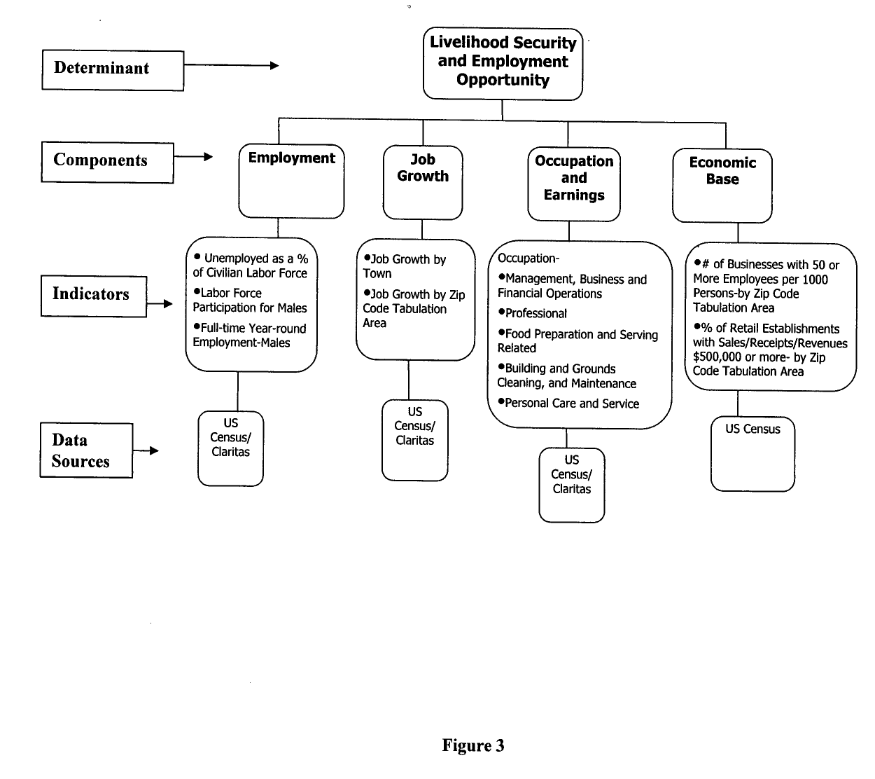

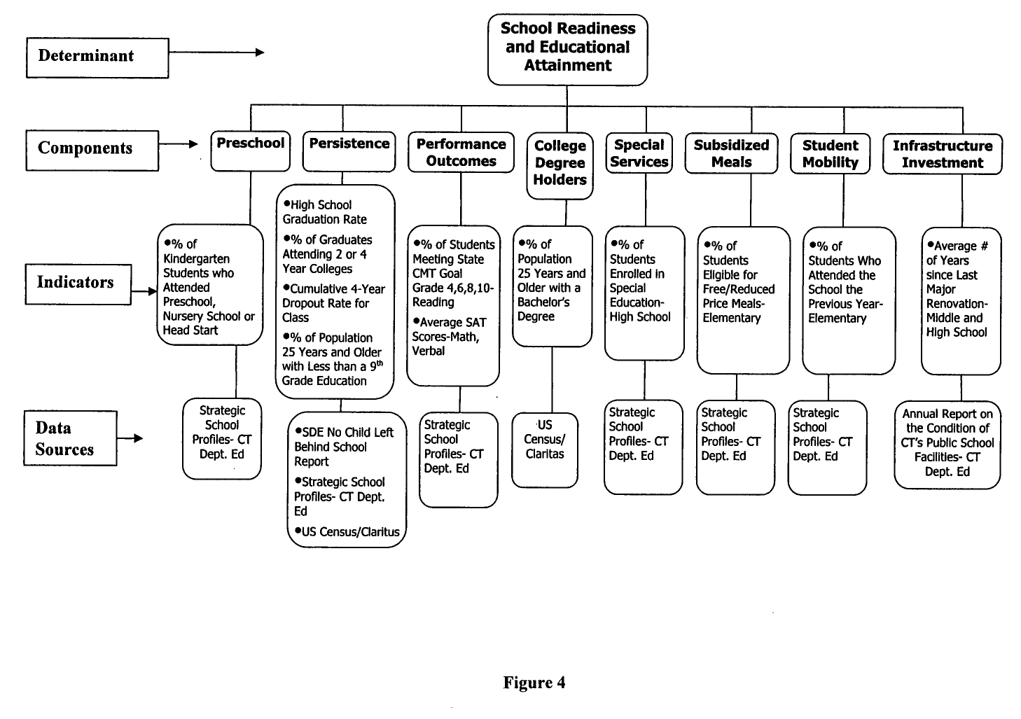

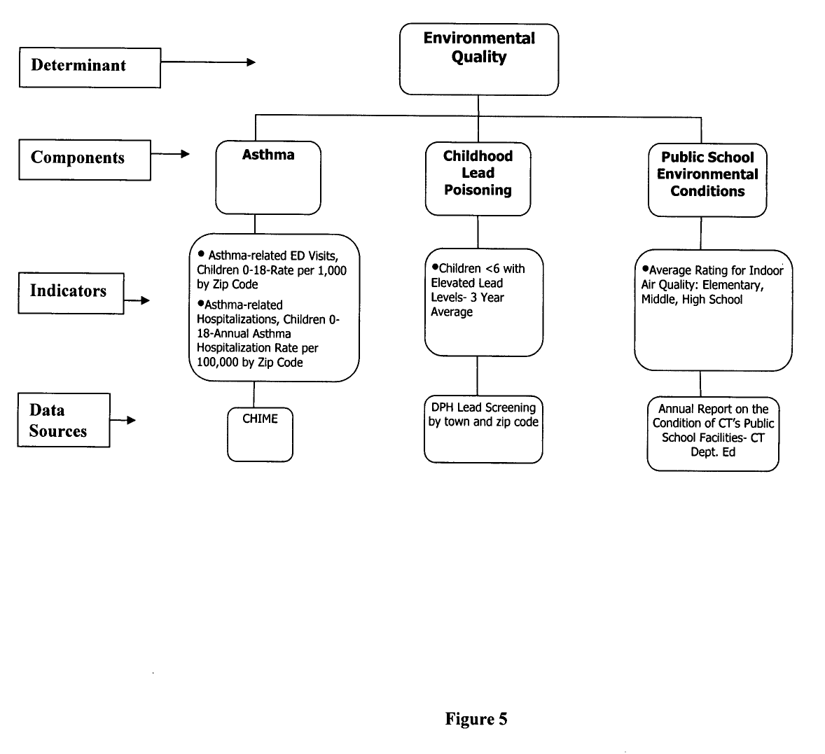

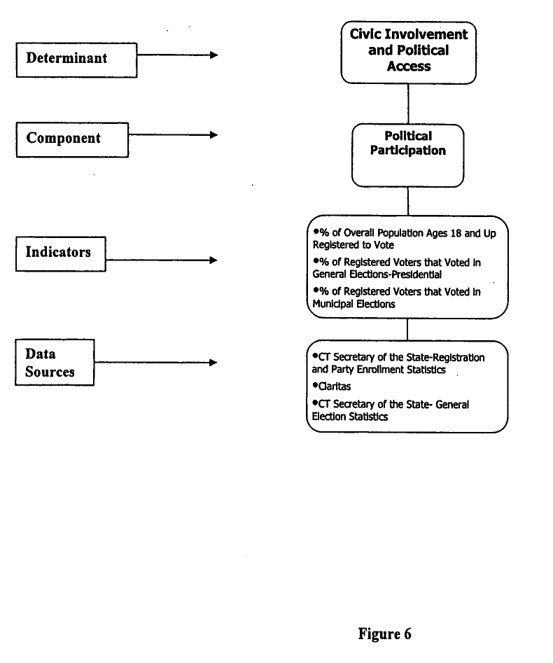

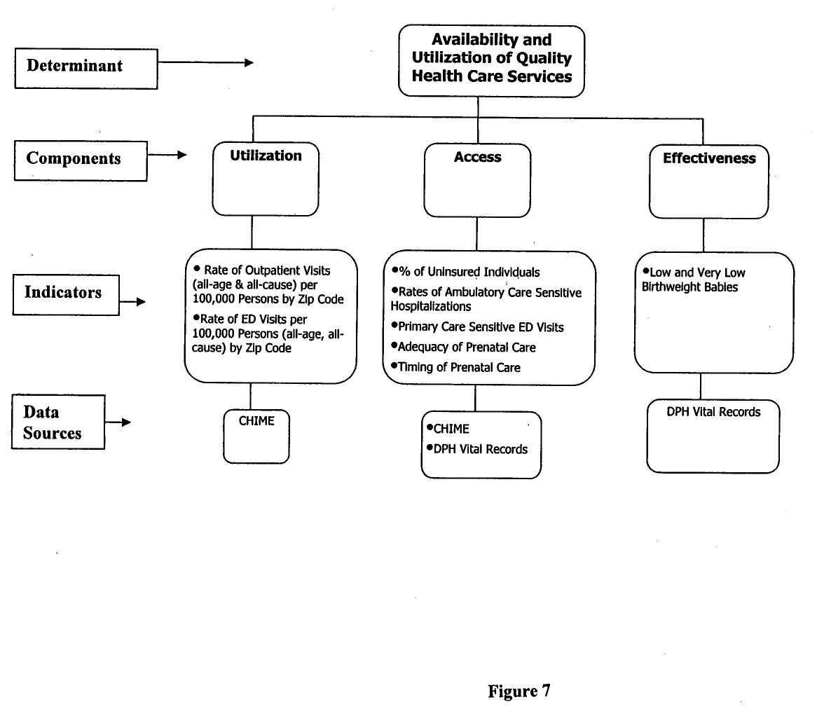

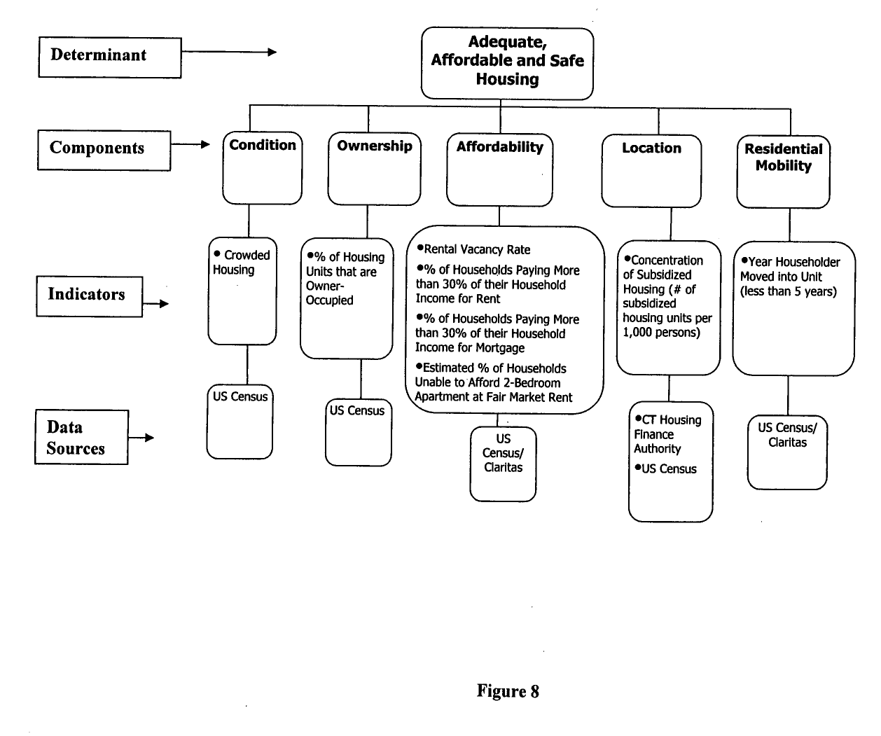

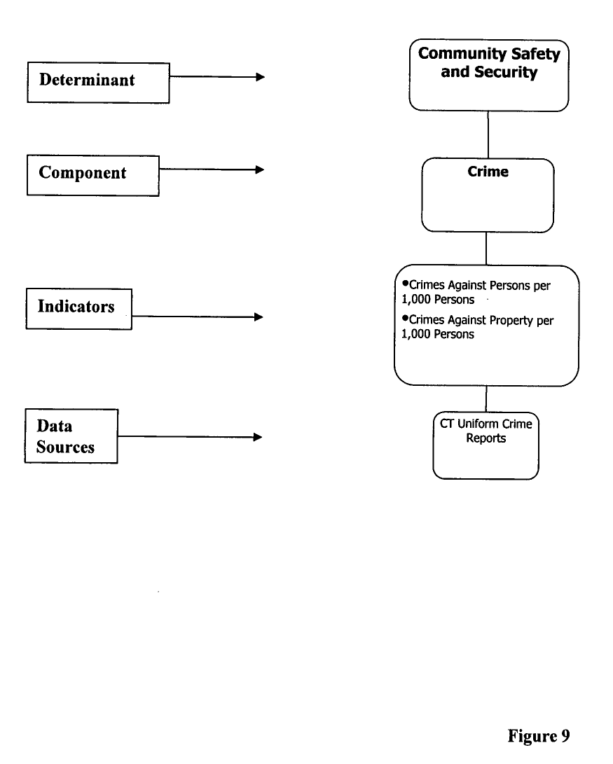

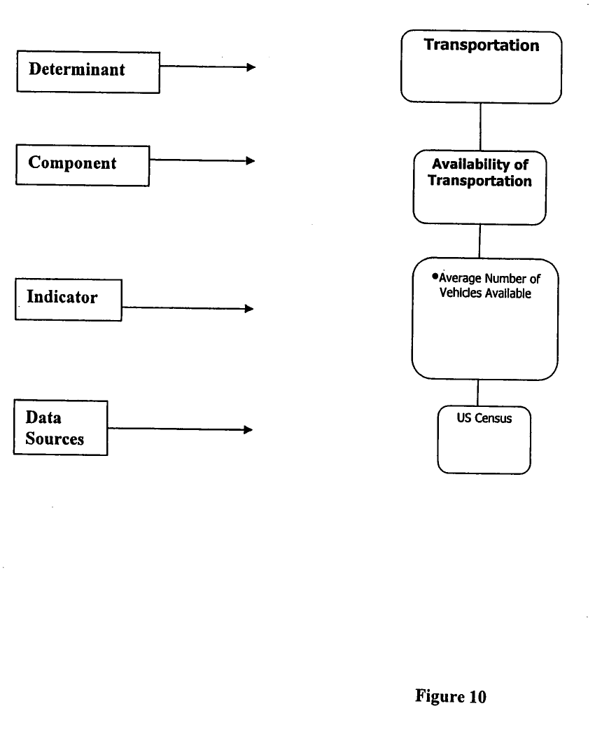

FIGS. 3-10 are similar schematics for each of the other eight determinants in the present example concerning community health. As evident from FIGS. 2 to 10, a total of 71 core indicators are distributed among the components. As an example, the Economic Security and Financial Resources determinant consists of five components and 14 indicators
Income (1 indicator)
Wealth/assets (4 indicators)
Poverty (4 indicators)
Public Assistance (3 indicators)
Access to Capital (2 indicators)

Each data for each indictor is obtained from a government or private database source 36 in which the relevant data is stored or derivable according to geographic or similar community units, e.g., census tract, postal zip code, telephone area code, voting district, taxing district, fire district, etc. In some instances, a small town may be a suitable community. For present purposes, the term “census” encompasses all such database sources. Whereas health assessment or other demographic assessment tools may currently be in use, they focus on larger, more homogenous regions such as countries, states, or counties.

In the present example, data sources had to be available for all 169 towns in Connecticut and at the census tract or zip code level. Once these two requirements were met, the appropriateness of a given data source was determined by seven additional conditions: reliability, validity, sensitivity, relevance, measurability, statistically sound, and capable of being disaggregated.

Core indicators 22 fully meet the selection criteria and answer two questions. “What is the size or magnitude of the health inequities?” “Where do the health inequities exist?” Core Indicators underpin the basic function since they have reference points and measurement scales that are used to calculate scoring.

Another set of indicators (represented at 22A in FIG. 1), for example as many as 250, can be considered complementary, in that they do not meet all of the indicator selection criteria or directly contribute to the calculation of the Core Index but they may be subject to analysis via correlation with the Core Index, various components, or various other indicators. Complementary Indicators are measures that can be used by communities to support further, in-depth analysis of the issues raised by the index and calculated correlations. They help to answer the question, “Why is this an inequity?” As such, Complementary Indicators move the analysis “upstream” by placing greater focus on the source of a disparity. Complementary Indicators have been developed in twenty areas:
Urban Environment/Physical Aspects of a Neighborhood
Housing Condition
Housing Affordability
Residential Segregation
Nutrition/Life Style
Natural Environment
Transportation
Political Access and Power
Community Agencies and Resources
Social Cohesion
Stress
Work Environment
Basic Needs
Early Care and Education
Economic Development/Area Business Capacity
Educational Infrastructure
Teachers: Qualifications; Absences; Turnover
Educational Attainment
Health
Public Transit

Identifying Indicators specify the population groups most affected by disparities from demographic and health outcome perspectives. They answer two fundamental questions. “Who is most affected by the inequities?” “How are they affected in terms of health status and health outcomes?”

Demographic Identifying Indicators (represented at 38 in FIG. 1) enable communities to examine existing disparities by race/ethnicity, income level, age, female-headed households with children under 18, and educational levels.

Health Outcome Identifying Indicators (represented at 40 in FIG. 1) make possible the analysis of disparities by the incidence or prevalence for certain diseases, causes of mortality and years of potential life lost.

A comprehensive listing of data sets for many of the indicators referred to herein for the preferred embodiment or which could be incorporated into other embodiments may be found in “Data Set Directory of Social Determinants of Health at the Local Level”, M. Hillemeier et. al., published in partnership with the Social Determinants of Health Work Group at the Center for Disease Control and Prevention, U.S. Department of Health and Human Services.

Much of the indicator, demographic, and health outcome data 22, 22A, 38, and 40 are downloaded into the system via links to the U.S. Census Bureau as represented at 36 in FIG. 1. Federal and state laws require that states, municipalities, hospitals, police departments, housing authorities, banks, social services departments, health departments, and other institutions maintain detailed records which are compiled centrally and available via data links.

The data in the system memory that populate the database according to the applications program, would generally be downloaded and entered into the system by the system provider, before acceptance of the system by the end user, such as a municipality. The present invention can thus be embodied in a system containing the application program in which the functional elements shown in FIG. 1 are specified before the data are loaded, as well as the operational system in which the data have been loaded. Generally, the system provider will deliver a system or configure a system in the end user's facility, according to the reference population and community subsets of interest to the end user. The scale used for the indicators may also be customized according to the end user's preference.

For example, for the indictor of median household income, the reference community may be a state, such as Connecticut @$60,538. For a selected community such as the Blue Hills neighborhood of Hartford, Conn., the census data reveals a median household income of $35,699. In order to relate the community to the state, this indicator has been assigned an integer point scale of 1-10, with $12,000 income increments, for both the state and the community. Blue Hills falls in category 3, and is thus assigned a raw score of 3 points.

The raw score for the core index is based on 71 core indicators and since each core indicator has an associated ten point scale, the raw total can range from 71 to 710. However, it is preferred to normalize or standardize the index so as to equate the power and contribution of each Determinant. This can be achieved by adjusting the differences in the number of core indicators for each Determinant, such as by dividing the total summative score for each Determinant by the number of core indicators that Determinant was composed of. This leads to a Standard Score Range of 9 to 90 for the Core Index.

As an aide to interpreting standard index scores in relation to more specific data such as for indictors or health outcomes, another five category Index scale can be established:

| | |
|---|---|
| Very Low | 9.00-25.2 |
| Low | 25.21-41.4 |
| Moderate | 41.41-57.6 |
| High | 57.61-73.8 |
| Very High | 73.81-90.0 |

The Core Index is useful as a quantitative measure of the overall health of a small community, such as neighborhood, using a larger community such as a state, as the reference. Due to the quantitative nature of the tool, governmental and charitable institutions can predict how changes in any one or combination of the 71 indicators will affect the overall health of the neighborhood. For example, the Health Index could be used as a health impact analogue to the environmental impact statement that is required to be submitted for approval to environmental regulatory agencies before major construction or earth moving projects can begin. The core index can also be used to direct resources into a particular neighborhood based on the particular one or few indicators on which the index exhibits the highest sensitivity to increases. Moreover, for a given city or county, use of the system at a neighborhood level may very well show that different neighborhoods would benefit most by different mixes of resources.

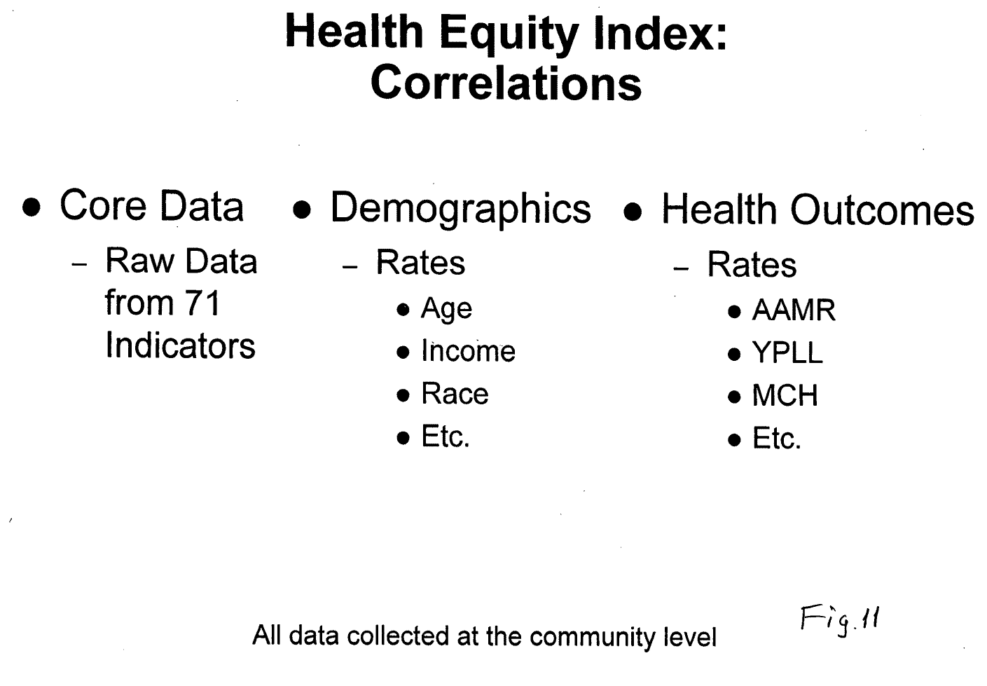

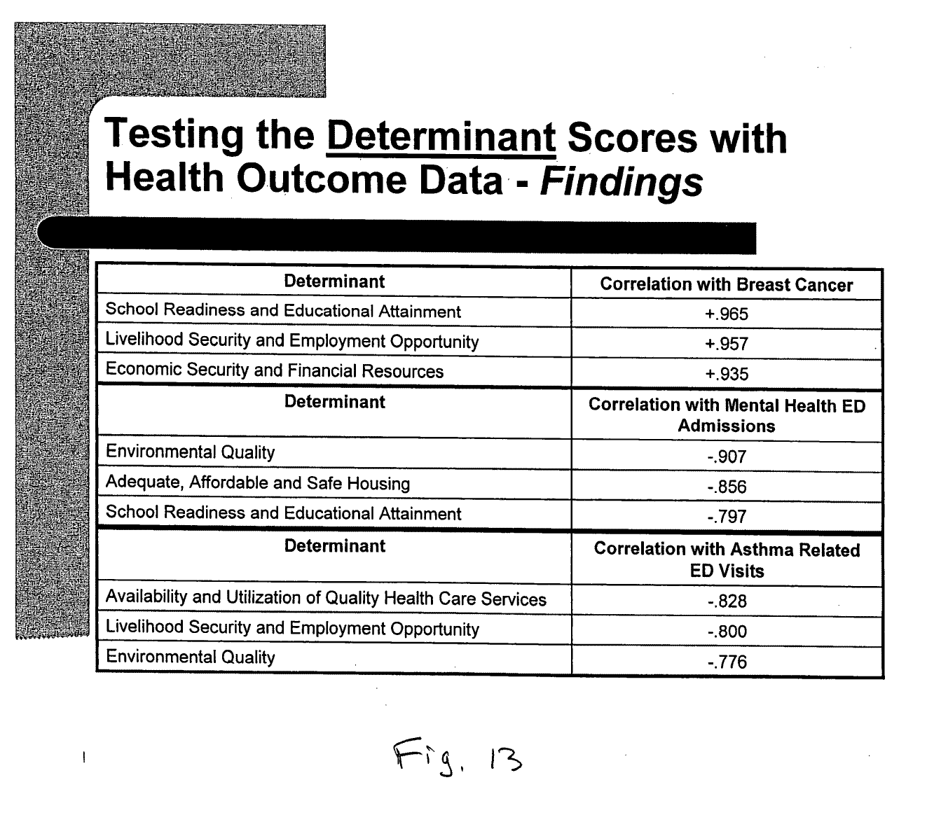

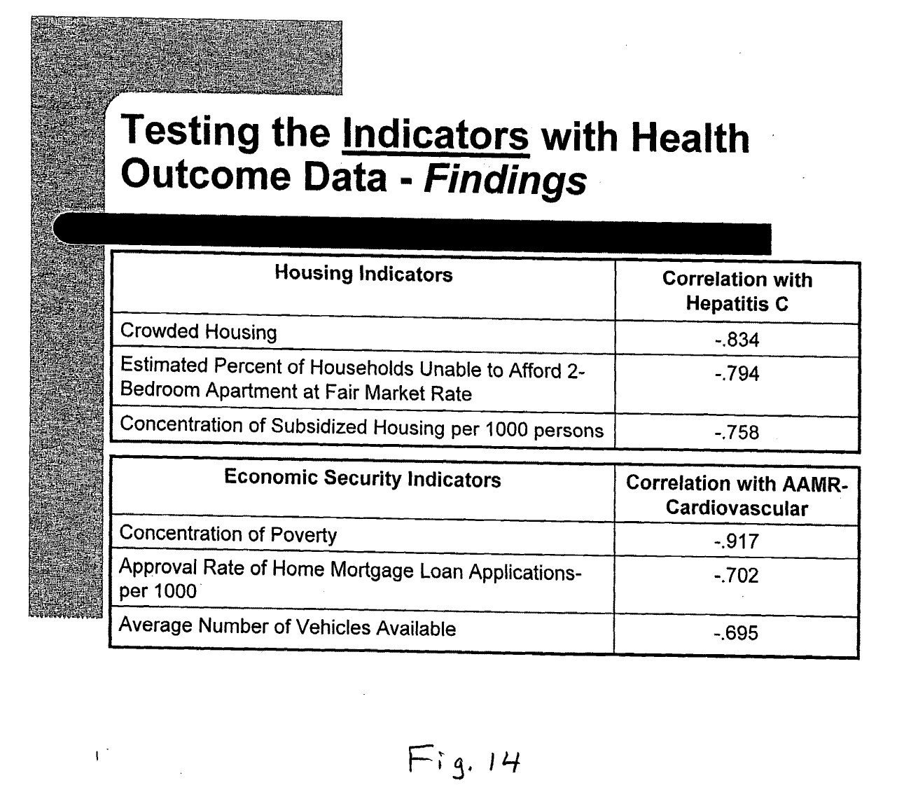

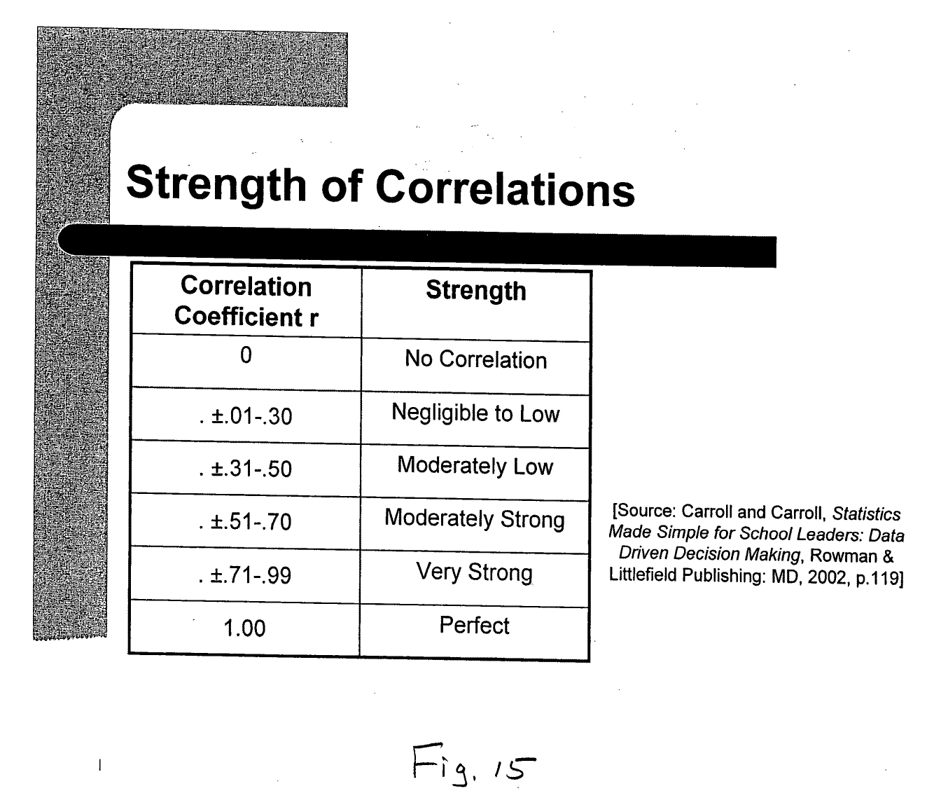

The system provides for additional quantitative analyses. As indicated in FIGS. 1 and 2, the Core Index 28 can be correlated with individual core components 24, or with individual core indicators 22. Similarly, core indicators 22 and core components 24 can be correlated. Importantly, as shown in FIGS. 1, 2, and 11-14, a Determinant 28, a Core Component 24, or a Core Indicator 22 can be correlated with Demographic data 38 or Health Outcome data 40. For example, correlations can be computed for at least 13 demographic characteristics available from public databases relating to race/ethnicity; gender; age; place of residence; educational attainment, income. FIG. 15 shows an exemplary table of correlation strength.

The exemplary system has produced correlations showing that the higher the Index Score for a community, the higher the percentage in that community of
White racial/ethnic groups
Higher median household income levels
Bachelor's Degrees
Advanced Degrees
Older residents

The lower the Index Score, the higher the percentage of
Hispanic racial/ethnic groups
Black/Hispanic racial/ethnic groups
Female-headed Households, with Children <18
Residents with less than 12th Grade education
Residents with less than 9^{th} Grade education

Publicly available database information supports analysis of at least 43 health outcomes, e.g., incidence/prevalence for illness, disease and injury (accidental and intentional); mortality and years of potential life lost (YPLL).
Mental Health Inpatient Hospitalization
Mental Health Emergency Dept. Treatment
Hepatitis C
Chlamydia/Gonorrhea
AIDS/HIV
Asthma Inpatient and ED Treatment <18
Elevated Blood Lead Levels
Cancer Incidence
   Stomach
   Colon
   Lung
   Prostate
   Breast
   Oral, Esophagus, Larynx
Age Adjusted Mortality Rates (AAMR) and Years Potential Life Lost (YPLL)
Cardiovascular Disease
Cancer: Overall; Breast; Cervical; Colon; Pancreatic; Prostate; Trachea, Bronchus & Lung
Respiratory Diseases
Diabetes Mellitus and Diabetes-related
Maternal and Child Health
   Adequacy of Prenatal care
   Timing of Prenatal Care
   Low Birth Weights

Testing of the exemplary Core Index of a community with Health Outcome Data 40 for that community indicates that the lower the Index Score, the higher the percentage of
Mental Health ED Treatment
Hepatitis C, Chlamydia/Gonorrhea, AIDS/HIV
Asthma ED and Inpatient Hospitalization
Elevated Blood Lead Levels
Less Adequate Prenatal Care
Later Prenatal Care

The lower the Index Score, the higher the percentage of
Age Adjusted Mortality Rates
Cardiovascular Disease
All Cancers
Diabetes Mellitus and Diabetes-related
HIV
Intentional Injury

The lower the Index Score, the higher the percentage of
Years Potential Life Lost
Cardiovascular Disease
Respiratory Diseases
All Cancers
Diabetes-related
HIV
Intentional Injuries

The higher the Index Score, the higher the percentage of
Cancer Incidence—overall
Breast cancer
Colon cancer
Lung cancer

As explained above, the core indicators and the health outcome data can be scaled based on statewide data, with the state median used a reference point to establish score interval ranges. The community data have a single, primary value for each type of indicator and each type of health outcome as obtained from the primary sources of data, which primary values can be simplified to scored values according to where they fall within the score intervals associated with the statewide data.

The present invention permits a variety of comparisons to be made. In a representative example, the reference group is composed of the aggregated subgroups of all municipalities in a state, and has an associated reference index and reference indicators and reference outcomes. Each municipality is composed of a plurality of census tract communities. A public health official of one municipality seeks to uncover health disparities among, say five communities that constitute that municipality. The following comparisons would be of interest.
Each community index vs. the reference Index
Each community index vs. every other community index
Each pair of (community index, primary outcome type) correlated over (community index, primary outcome type) for all communities
Each pair of (community index, scored outcome type) correlated over (community index, scored outcome type) for all communities
Each pair of (primary indicator type, primary outcome type) correlated over (primary indicator type, primary outcome type) for all communities
Each pair of (scored indicator type, scored outcome type) correlated over (scored indicator type, scored outcome type) for all communities

Some comparisons, such as the first two, provide qualitative information that can point toward further inquiries. Other comparisons, such as the correlations, provide quantitative information on the direction and magnitude of a possible linear relationship between variables (such as a particular type of indicator and a particular type of health outcome), i.e., they do not appear to be independent of each other within the municipality if the correlation is significant. The well known Pearson product-moment correlation technique can be used for this purpose, but with small data sets simpler techniques (such as simple linear regression with least squares estimates) can be used.

Given that the system as used in a municipality will have primary data for, e.g., at least dozens of indicators and at least dozens of health outcomes for each community, a multivariable regression analysis can also reveal useful relationships. In this case, two types of indicators are selected as independent variables and one type of health outcome is selected as a possible dependent variable, with the regression analysis showing how the typical value of the health outcome changes when one of the indicators is varied while the other indicator is held fixed.

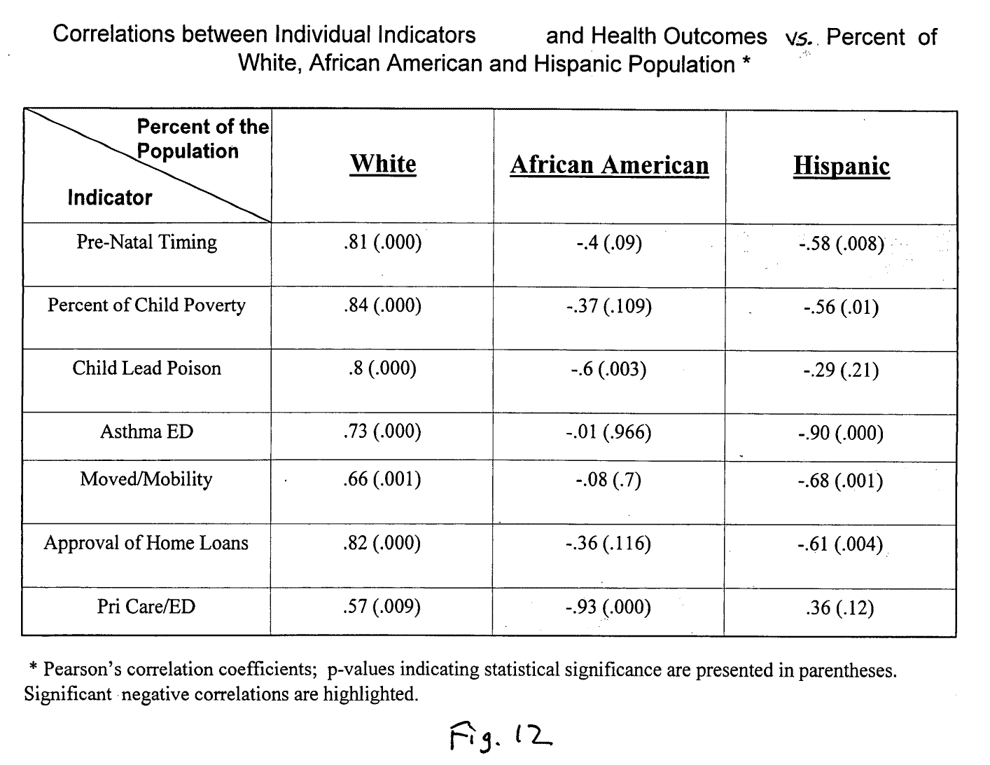

Demographic data for the population of each community can also be used in the same way as an indicator for a variety of comparisons. Whether or not a demographic database for the community is stored, if the source of health outcome data includes a demographic breakdown of health outcomes in each community, such as rate of a particular disease by gender, age, and race, a further level of comparison can be obtained and displayed that is not available from only community demographics. This is how the correlations shown in FIG. 12 were obtained.

Mapping can be a very powerful tool for visually portraying the comparisons. Indicator data can be displayed in relation to health outcome information. In addition, the presence or absence of important neighborhood assets such as public transportation, day care facilities, supermarkets, primary care physicians, recreational areas and others can be overlaid onto areas with documented disparities. The same can be done with housing code violations, tax delinquent properties, and other areas. Doing so will contribute to a community's understanding of where disparities exist, and why.

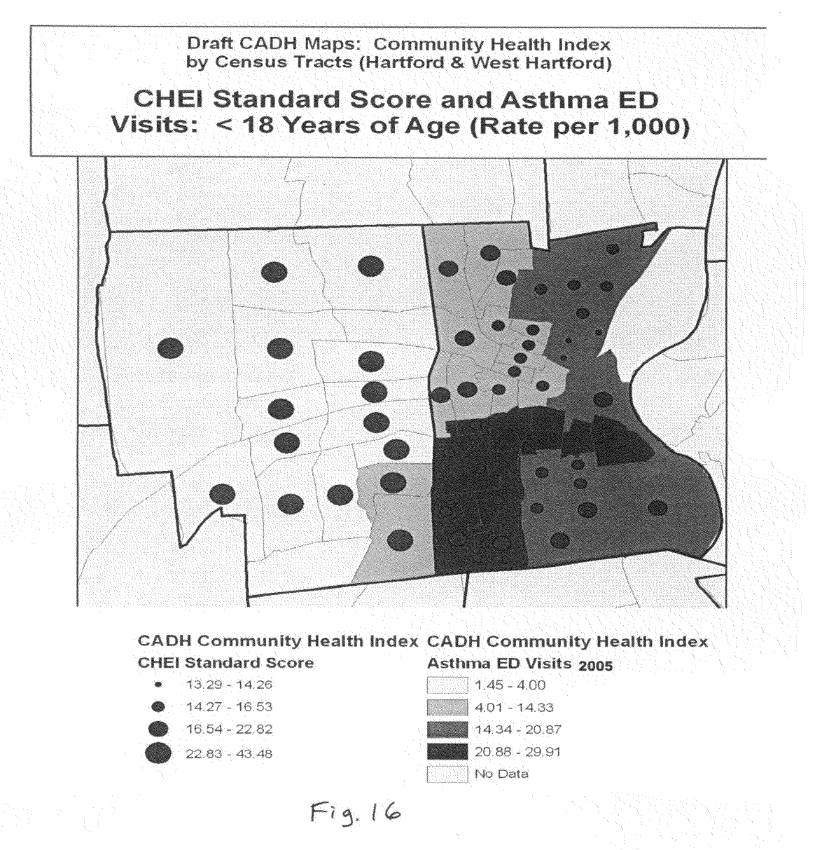

One such map is included as FIG. 16, where three kinds of information are shown simultaneously in a graphic form that can be displayed on a monitor or printed. The census tract boundaries for each of the 20 communities reveal the geographic relationships of the scored index for each community shown as the size of the oval and the rate of asthma ED visits according to the color or shading of the census tract.

Appendix A sets forth the definitions used in the exemplary embodiment directed to a core index for community health. Appendix B lists the indicator selection criteria for such a core index. Appendix C sets forth in greater detail, the logic associated with the system and method of the invention as implemented for a health equity index for use in the state of Connecticut. Appendix D describes how the system and method can be configured for the particular needs of end users, such as municipalities or other governmental agencies. Appendix E provides further details on the database scheme of the preferred embodiment.

### APPENDIX A

### Definitions Developed for the Index

1. Social Determinants of Health Equity. The specific processes and pathways by which societal conditions affect population health and can be influenced by informed action. Examples include income, education, occupation, wealth and assets, environment, access to health care and housing conditions.
   Larger social-institutional forces in turn affect the determinants. These include discrimination based on race, class, gender, and age; segregation; lack of political control and access to decision-making structures; and public and corporate policies that affect labor markets, trade, taxes, wages, land use and regulations.
2. Disparity. The quantity that separates a group from a specified reference point on a particular measure of health equity that is expressed in terms of a rate, percentage, mean, median or other quantitative measure.
3. Inequity. The presence of unjust, unfair and avoidable social or health disparities between groups based on race/ethnicity, gender, age or place of residence, socioeconomic status.©
4. Index. A numeric scale used to compare two or more indicators with one another or with a reference number. A summary or statistical composite of two or more indicators that represents the general trend, performance, or condition of a system.
5. Indicator. A measurement used to describe the contextual condition, characteristic, event or a behavior associated with a population group and (for a Core Indicator) known to have a scientific basis for affecting the health of individuals in the group or (for a Complementary Indicator) believed likely to affect the health of individuals in the group.
6. Reference Point. The specific value of a rate, percentage, mean, median or other quantitative measure from which a disparity can be measured.
7. Measurement Scale. A numerical scale used to compare variables against a designated reference point.
8. Median. The figure in a range of data that falls midway in the series between the highest and lowest values.
9. Proxy Measure. A stand-in measure used to approximate an actual condition, outcome or event when a direct measure is not feasible to data collection, time or resource constraints.
10. Numerator. The upper portion of a fraction used to calculate a rate, proportion or ratio, i.e., number of persons or households in a geographic area with the characteristic of interest or the number of cases or observed events.
11. Denominator. The lower portion of a fraction used to calculate a rate, proportion or ratio—the population for a rate-based measure, i.e., the total number of persons or households in a geographic area being measured, the total number of persons served.
12. Absolute Measure of Disparity. A simple arithmetic difference between a group rate and a specified reference point.
13. Relative Measure of Disparity. Expresses the difference between the rates in terms of the chosen reference point. The percentage difference expresses the simple difference between the group rate and the reference point as a percentage of the reference point.
14. Demographic data: Data on inherent personal characteristics other than health, such as race, age, gender, income, education level, etc.
15. Health Outcome data: Data on disease, treatment, mortality, or other personal health condition that is manifested by individuals.

### APPENDIX B

### Core Indicator Selection Criteria

1. Availability. Data for the indicator are readily available and affordably accessible from a reliable source.
2. Reliability. Data for the indicator are consistently collected, compiled and calculated in the same way, from year to year.
3. Validity. The indicator measures what it is designed to measure—a specific factor or condition directly related to a social determinant of health.
4. Measurability. The indicator can easily be quantified and lends itself to numerical scaling based upon a chosen reference point.
5. Relevance/action-oriented. The indicator measures a factor or condition concerning a social determinant of health over which community stakeholders can achieve positive change through public decision-making and social/political action.
6. Capacity to be disaggregated. The data can be disaggregated into target groups of interest based on race/ethnicity, gender, age and residence.
7. Sensitivity. The indicator is able to capture changes in conditions over time.
8. Compelling and Interesting—lends itself to understanding and has the capability to resonate with the public, media and decision-makers
9. Statistically sound. Indicator construct (measurement and scaling) is methodologically sound and is appropriate for the purpose it is being applied. The indicator has been used in other indices or indicator systems.

### APPENDIX C

### Instructions for Conducting the Health Equity Index

1. Develop the Reference Points and Ten-Point Measurement Scales
   Determine the reference point (median) for each indicator
      Refer to the indicator's data source
      Access the data for the state (Connecticut—169 towns); databases include:
         US Census
         Connecticut Education Database and Research
         CHIME Hospital Discharge Data
         Uniform Crime Reports
         Home Mortgage Disclosure Act Loan Application Register
      Calculate rates (where necessary) using the numerator/denominator formulation for each indicator
      Organize data in ascending or descending order according to rank
      Determine the reference point (median or mid-point of the range of data)>
   Calculate the ten-point measurement scale
      Divide the reference point (median) by five
      Use the resultant integer to calculate ten gradients, with five intervals below the reference point and five above it
2. Determine the Unit of Analysis
   Determine how the data will be analyzed
      City/town,
      Zip code, or
      Neighborhood
   Organize the census tracts by neighborhood or zip code (if using those units of analysis)
3. Collect Health Equity Index Data
   Access the data source for each indicator
   Determine the indicator's data point (number, rate, percent) for the unit of analysis (town, zip code or neighborhood)—use the numerator/denominator formula established for each indicator
   Record the data on the HEI Data Collection Form (attached)
4. Tabulate Indicator Scores
   Determine the composite score for the neighborhood or zip code (if using those units of analysis)
   Assign an indicator score of 1-10 based on the data point's placement on the measurement scale
   Check each score for computational accuracy
5. Calculate Raw Scores by Determinant and Overall Score
   The HEI is composed of seventy-one (n=71) indicators. Since each of the indicators can receive a score between one (1) and ten (10) for scaling, the lowest raw score possible on the HEI is 71 (17×1) and the highest raw score is 710 (71×10).
   The range of raw scores by Determinant is as follows:
      Economic Security and Financial Resources: 14-140
      Livelihood Security and Employment Opportunity: 12-120
      School Readiness and Educational Attainment: 17-170
      Environmental Quality: 6-60
      Civic Involvement and Political Access: 3-30
      Availability and Utilization of Quality Health Care Services: 8-80
      Adequate, Affordable and Safe Housing: 8-80
      Community Safety and Security: 2-20
      Availability of Transportation: 1-10
6. Calculate Standard Scores for Determinants

### For One Determinant

Because of the variety in the number of indicators per Determinant, standard scoring was conceived. It is a method to equate the power and contribution of each of the Determinants to the overall Index. For example, the Education Determinant has 17 indicators while the Transportation Determinant has one. Standard scoring adjusts the disparity in the number of indicators for each Determinant.
Standard scoring is accomplished by dividing the total summative score for each Determinant by the number of indicators that the Determinant was composed of. This results in a ten-point scale.
Using the ten-point scale, immediate inferences can be observed on Standard Scores by unit of analysis. When Standard Scores are in rank order, interpretation becomes even more immediate

### For Multiple Determinants

Cross comparison analysis can be undertaken among Determinants because the scores are standardized.
Complete the standard scoring for each Determinant as outlined above.
Arrange the Standard Scores for each Determinant by the unit of analysis in chart form.
7. Calculate Standard Scores for the HEI Score
   For raw scores, the nine Determinant raw scores are summed to get the Total Raw score. The same procedure is used to get the total Standard Score. Each of the Determinants' Standard scores is summed to get a total score.
   Raw scores and Standard scores produce slightly different information on the unit of analysis. This is due to the range in the number of indicators used to calculate Raw scores. The use of Standard scores produces a better and more balanced result for the unit of analysis. It is recommended that only the Standard scores be used for the HEI although they are derived from the raw scores.
8. Correlate HEI Scores with Health Outcome Data
   Select the Health Outcomes to be analyzed
   Obtain the data from the identified data sources
   Calculate rates for the unit of analysis (Incidence; Age-Adjusted Mortality Rates; Age-Adjusted Years Potential Life Lost)
   Record the data on HEI Data Collection Form—Health Outcomes (attached)
   Enter Health Outcome rates into SPSS
   Execute correlation statistic
9. Correlate HEI Scores with Demographic Data
   Select the Demographics to be analyzed
   Obtain the data from the identified data sources
   Calculate percentages for the unit of analysis
   Record the data on HEI Data Collection Form—Demographics (attached)>
   Enter Demographic rates into SPSS
   Execute correlation statistic

### APPENDIX D

### Local Configurations

The invention as described above is designed for the supplier to deliver a turn-key system that the purchaser or licensee can operate effectively with all data in place. However, it is contemplated that a sophisticated licensee might wish to acquire a system that has an intact foundation of data, with the option of the licensee adding detailed features. Moreover, it is also possible within the scope of the invention, that an end user might wish to acquire the core logic that defines the processing, but on its own obtain and validate all the data to populate data tables corresponding to, e.g., the data sources, indicators, components, and determinants as depicted in FIG. 2.

In general, for a representative but not limiting health equity index system as described herein:
1. Data that is common to, delivered with, and resides in all products, includes
   Index score(s) for every geographic unit of interest
   Correlations with demographic and health outcomes at multiple levels (determinant, indicator)
   GIS maps
2. Data that is installed uniquely for or at the local level and will reside locally, might include
   complementary data that is collected, via focus group, survey instrument that is specific to the locality
3. Data that is downloaded locally and transparently for all products after each local user logs in, might include local scores, determinant and indicator values, correlations, maps
4. Data unique to the locality that is downloaded locally and transparently after each local user logs in, might include complementary data would be unique to the locality and could be included in this category.
5. Data that the local user could originate and enter locally
   Complementary data collected locally via, survey/focus group or other means.
   Neighborhood boundaries—based on standardized units like census track or block group
6. Selection of display or other output options available to the local end user
   Could be quite extensive
   Index score(s) for every geographic unit of interest
   Correlations with demographic and health outcomes at multiple levels (determinant, indicator)
   Mapping
7. The local user can have options in specifying
   a. Which complementary indicators are used, and how they will be collected locally, optionally key informant interviews, focus groups, surveys
   b. Non-standard neighborhood boundaries using standardized units such as zip code, census tracts etc.
   c. Number and type of Demographic and Health Outcomes items in that that some end users may want to run correlations against other outcomes of interest such as youth violence

The term ‘data’ as used above, refers to the specific data points that are inputted that contribute to the Index, scores and correlations.

### APPENDIX E

### Database Schema

### The Structure of the Data

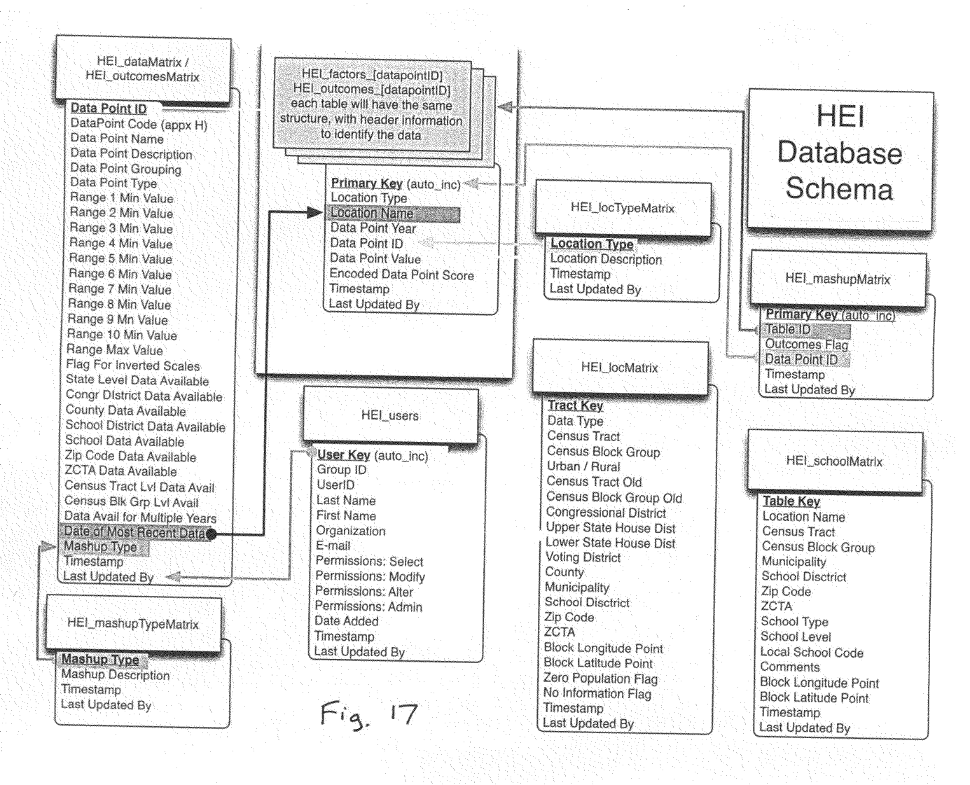

FIG. 17 provides an overview of the schema of the database, showing one implementation for the relationships between the tables and fields. The database is made up of three types of tables:

Index Tables, containing matrices that cross-reference and index the data; Data Tables, containing the largest portion of the database where all the data are stored; and System Tables, container user information.

### The Index Tables

The first type of table is an index set of six tables. These six tables track data relationships for the following:
The Data Matrix/The Outcomes Matrix
The Location Matrix
Location Types
The School Matrix
The Mashup Matrix
Mashup Types

### HEI_dataMatrix/HEI_outcomesMatrix

The data matrix contains information about the data points, both as source data and derived data values, including core, complementary, health outcomes and identifying (demographic) indicators. It includes the resolution at which the data has been stored, the date for which the data was acquired, and where to find the data points in the database. It also contains the values for converting source data into point scores on the specified ten-point scale. These are the reference data points used for developing models to predict outcomes.

### HEI_locMatrix

The location matrix cross-indexes information about locations, and allows cross-indexing across levels of resolution. This table is indexed by census block group.

### HEI_locTypeMatrix

The location type matrix tracks the four-character location codes used to identify levels of geographic resolution.

### HEI_schoolMatrix

Information about schools, which don't easily fit the location matrix due to their extensively overlapping regions of influence. This allows the geographic patterns of the schools to be overlaid on the geographical hierarchy in the location matrix. This table is indexed by school name and is used to track the level and type of school and the location of the school in relation to some key geographic identifiers. It is meant to allow reference back to HEI_dataMatrix/HEI_outcomesMatrix and uses more than one geographic identifier to allow this. The school names indexed in this table also match the location names in the data point tables.

### HEI_mashupMatrix

The mashup matrix cross-indexes table names and data set names for data sets that occur in tables with names that do not match the data set name.

### HEI_mashupTypeMatrix

The mashup type matrix tracks the four-character mashup codes that define the relationship between table names and data set names. This value appears in the MashUp field of the HEI_dataMatrix and HEI_outcomesMatrix

### Data Tables

The second type of table is the table for the data points.

There is one table for each reference data point set with the name HEI_factors_datapointname.

There is one table for each outcome measure with the name HEI_outcomes_datapointname. They both have the same format. The only reason for the difference of name is one of programmatic and conceptual clarity.

The tables store the value and score for the data point, the geographic source for the data, the detail level at which that record has been recorded, the year for which the record contains data, and the data point name.

Since the data tables are named by data point name, they are easy to access programmatically by first referring to the data matrix or outcomes matrix table to get the name. This also means the matrix tables should be used to log all new compound or breakout data tables that are created.

The index score for the data is based on a ten-point scale ranging from one to ten.

### System Tables

There is a user-tracking table named HEI_users that is used to track people working with the data. No one who is not listed as a user in this table should be modifying data in the database, since it is used to identify last worked with the data.

1. A computer system having a data storage memory, an operating system for accessing data in the memory, an application program compatible with the operating system, and a user interface for the operating system and application program, wherein the system comprises:
a database stored in said memory, containing census data on a specified geographic community, each datum of the database representing a quantitative indicator value indicative of one of a plurality of components of community condition;
executable instructions for combining with weighted importance, the quantitative indicator values into a plurality of said components of community condition, each of said components representing a quantitative value associated with one of a plurality of determinants of community condition;
executable instructions for combining with weighted importance, the quantitative component values into a determinant of community condition, each of said determinants representing a quantitative contribution to an index commensurate with the overall condition of the community; and
executable instructions for computing said index from said determinants and displaying the index on the user interface.

2. The system of claim 1, wherein the user interface is one of a local or remote screen display, printer, or image projector.

3. The system of claim 1, wherein the community condition is human health.

4. The system of claim 1, wherein the community condition is one of economic vitality, human happiness, and satisfaction with government services.

5. The system of claim 1, wherein the community is one of a census tract, postal zip code, municipal voting district, school district or telephone area code.

6. The system of claim 1, wherein
the database contains indicator data for a multiplicity of communities as a collective reference group and indicator data from a plurality of individual communities from the reference group; and
the application program scores the indicators for each community in relation to a reference value representative of the reference group of communities.

7. The system of claim 6, wherein the reference group of communities is a state.

8. The system of claim 1, wherein the application program includes a quantitative scoring scale for each indicator and the executable instructions assign a particular quantitative score for each indicator based on the census data.

9. The system of claim 8, wherein the scoring scale is centered on a reference value representing a larger group of communities.

10. The system of claim 8, wherein the executable instructions sum the scores for all indicators of each component and weights each indicator for a given component such that the sum of the maximum permissible values of all components for each determinant is equal.

11. The system of claim 1, wherein each indicator is indicative of a condition that is likely to affect the health of a population, is measurable and scalable for a reference population of a reference group of communities selected from the reference group of a state, county or city and is measurable and scalable for each community of a subgroup of said communities selected from the subgroup of census tract, postal zip code, telephone area code, school district and municipal voting district.

12. The system of claim 11, wherein the scale for the community population is the same as the scale for the reference population.

13. The system of claim 1, wherein health outcome data comprises the incidence rate of at least one of particular illness, disease, accidental injury, intentional injury, mortality, and years of potential life lost (YPLL).

14. A computer system having a data memory, a database containing predefined data stored in the memory, an operating system for accessing data stored in the memory, an application program compatible with the operating system and containing coded instructions for accessing the data and executing logic and arithmetic operations, and a user interface for the operating system and application program, comprising:
census data on a specified geographic community, each datum of the database representing a quantitative indicator value indicative of one of a plurality of components of community health;
executable instructions for combining with weighted importance, the quantitative indicator values into a plurality of said components of community health, each of said components representing a quantitative value associated with one of a plurality of determinants of community health;
executable instructions for combining with weighted importance, the quantitative component values into a determinant of community health, each of said determinants representing a quantitative contribution to an index commensurate with the overall health of the community;
executable instructions for computing said index from said determinants; and
executable instructions for comparing said computed index with a similarly computed index for at least one different community.

15. The system of claim 14, wherein
The census data is specific to each of a plurality of geographic communities, each datum of the database representing a quantitative indicator value indicative of one of a plurality of components of community health for each community;
executable instructions for combining with weighted importance for each community, the respective quantitative indicator values into a plurality of said components of community health, each of said components representing a quantitative value associated with one of a plurality of determinants of community health;
executable instructions for combining with weighted importance for each community, the quantitative component values into a determinant of community health, each of said determinants representing a quantitative contribution to an index commensurate with the overall health of the community;
executable instructions for computing said index from said determinants for each community; and
executable instructions for comparing said index as computed for each community.

16. The system of claim 15, comprising
health outcome data about each community;
scaled values for a reference index, scaled values for reference indicators, and scaled values for reference health outcomes for a reference group of communities;
wherein the values of the indices, indicators, and outcomes for each community are scaled values on the same scale as the respective reference index, reference indicators, and reference outcomes; and
executable instructions for comparing the scaled values of the scaled indicators and scaled outcomes for each community with each other and with the reference indicators and reference outcomes of the reference group.

17. The system of claim 16, including instructions for
(a) correlating the index values of the communities with the outcome values of the communities;
(b) correlating the indicator values of the communities with the outcome values of the communities; and
(c) generating a display of the correlations.

18. The system of claim 16, including executable instructions for correlating at least one of said quantitative indicator values indicative of a component of community health for a plurality of communities with a health outcome data for each of said plurality of communities.

19. The system of claim 16, including executable instructions for correlating at least one component for a plurality of communities with a health outcome data for said plurality of communities.

20. The system of claim 16, including demographic data for each community and instructions for correlating at least one determinant for a plurality of communities with a demographic data for said plurality of communities.

21. The system of claim 14, wherein each indicator is indicative of a condition that is likely to affect the health of a population, is measurable and scalable for a reference population of a reference group of communities selected from a state, county or city and measurable and scalable for each of a subgroup of communities selected from a census tract, postal zip code, telephone area code or municipal voting district.

22. The system of claim 14, wherein the scale for the community population is the same as the scale for the reference population.

23. The system of claim 21, wherein health outcome data comprises incidence rate of at least one of particular illness, disease, accidental injury, intentional injury, mortality, and years of potential life lost (YPLL).

24. A computer system having a data memory, a database containing predefined data stored in the memory, an operating system for accessing data stored in the memory, an application program compatible with the operating system and containing coded instructions for accessing the data and executing logic and arithmetic operations, and a user interface for the operating system and application program, comprising:
census data for a reference geographic boundary and census data for a plurality of local geographic boundaries that are a subset of the reference geographic boundary, each census datum representing a quantitative indicator value indicative of a condition that influences the health of individuals, measured at a reference level corresponding to the reference boundary and measured at community levels corresponding to the local boundaries;
health outcome data comprising rate of incidence of at least some of particular illness, disease, accidental injury, intentional injury, mortality, and years of potential life lost (YPLL), for the reference geographic boundary and each local geographic boundary; and
executable instructions for comparing any one of said indicators with at least some of any of said health outcome data, and for generating a graphic display of the correlation.

25. The system of claim 24, wherein each indicator and each health outcome is stored as a primary measurement and as a plurality of scaled scores associated with the primary measurement, for the reference population selected from a state, county or city and for each local community selected from a census tract or postal zip code.

26. The system of claim 25, wherein the scales for each local population are the same as the scales for the reference population.

27. The system of claim 25, including instructions for correlating the primary indicator values of the local communities with the primary outcome values of the local communities.

28. A method of operating a computer system having a memory, an operating system for accessing data stored in the memory, an application program compatible with the operating system and containing coded instructions for accessing the data, a database containing predefined data stored in the memory, and a user interface for the operating system and application program, wherein the application program executes instructions to perform the method comprising:
accessing stored census data for a reference population within a reference geographic boundary, including data of each of a plurality of types of contextual indicators of public health and data for each of a plurality of types of health outcomes;
for each indicator and each health outcome, determining a reference value and establishing reference scaled score interval ranges around the reference values;
combining the reference indicator values with weighted importance, to determine a reference index of contextual indicators of health outcomes;
for each of a plurality of community populations in respective defined geographic boundaries that are subsets of the reference population and reference geographic boundary, selecting from said census data, the corresponding subset of primary data on the same plurality of contextual indicators of public health and primary data on at least some of the same plurality of health outcomes, to obtain community primary indicators and community primary health outcomes;
for each community primary indicator and for each community primary health outcome, assigning an indicator score and a health outcome score according to the reference scaled score interval ranges;
for each community, combining the community scored indicator values with the same weighted importance as the weighting for the reference index, to determine a community index of contextual indicators of health outcomes;
comparing community indices of said plurality of communities with respective community health outcomes; and
determining whether the comparison shows that a type of health outcome is not independent of the indices, thereby implying the existence of a health disparity for that type of health outcome.

29. The method of claim 28, wherein the comparison is with community primary data outcomes.

30. The method of claim 28, wherein the comparison is with community scored value outcomes.

31. The method of claim 28, including
establishing index scaled score interval ranges around the reference index;
assigning a community index score according to the reference index scaled score interval ranges;
correlating the community index scores, with community health outcome scores; and
if the scores on a type of health outcome exhibit a significant correlation with the index scores, inferring the existence of a health disparity.

32. The method of claim 28, including
for a plurality of communities, correlating indicators and health outcomes;
assessing the direction and strength of the correlations; and
if a type of health outcome exhibits a significant correlation with a type of indicator, inferring the existence of a health disparity.

33. The method of claim 32, wherein the correlation is between primary indicators and primary outcomes.

34. The method of claim 32, wherein the correlation is between scored indicators and scored outcomes.

35. The method of claim 28, wherein the determination includes mapping the comparison using GIS methodology and graphically displaying the location and magnitude of disparities.

36. A method of operating a computer system having a memory, an operating system for accessing data stored in the memory, an application program compatible with the operating system and containing instructions for accessing the data, a database containing predefined data stored in the memory, and a user interface for the operating system and application program, wherein the application program executes instructions to perform the method comprising:
accessing stored census data for a reference population within a reference geographic boundary, including data of each of a plurality of types of contextual indicators of public health and data for each of a plurality of types of health outcomes;
for each indicator and each health outcome, determining a reference value and establishing reference scaled score interval ranges around the reference values;
for each of a plurality of community populations in respective defined geographic boundaries that are subsets of the reference population and reference geographic boundary, selecting from said census data, the corresponding subset of primary data on the same plurality of contextual indicators of public health and primary data on at least some of the same plurality of health outcomes, to obtain primary community indicators and primary community health outcomes;
for each primary community indicator and for each primary community health outcome, assigning an indicator score and a health outcome score according to the reference scaled score interval ranges;
for a plurality of communities, comparing an indicator and a health outcome;
determining whether the comparison shows that a type of health outcome is not independent of the indicator, thereby implying the existence of a health disparity.

37. The method of claim 36, wherein the comparison is a correlation between community primary indicators and community primary outcomes.

38. The method of claim 36, wherein the comparison is between community scored indicators and community scored outcomes.

39. The method of claim 36, wherein the determination includes mapping the comparisons using GIS methodology and graphically displaying the location and magnitude of disparities.

40. A computer readable media containing database data comprising a multiplicity of health outcome indicator data points and a multiplicity of health outcome data points, wherein
each of the health outcome indicator data points includes a quantitative value of a social condition that influences public health and includes the data attributes of
type of condition
source measured value
scaled score value
geographic unit
source of the measured value;
each of the health outcome data points includes a quantitative value of a rate of deficiency in human health and includes the data attributes of
type of deficiency
source measured rate of incidence
scaled score rate of incidence
geographic unit
source of the rate of measured rate;
wherein for each type of condition at least two indicator data points are present for a respective at least two different geographic units, each geographic unit corresponding to a census tract, postal zip code, municipal voting district, or telephone area code; and
wherein for each type of deficiency at least two outcome data points are present for the same at least two geographic unit attributes as said two indicator data points.
